(19) United States
(12) Patent Application Publication
(10) Pub. No.: US 2009/0015680 A1
(43) Pub. Date: Jan. 15, 2009

(54) Device, System and Method for Aligning Images

(76) Inventors: David P. Harris, Wilmette, IL (US); Michael G. Lyttle, Duluth, MN (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/167,752

(22) Filed: Jul. 3, 2008

Related U.S. Application Data
(60) Provisional application No. 60/958,910, filed on Jul. 10, 2007.

(51) Int. Cl. H04N 5/228

(52) U.S. Cl. 348/208.1; 348/E05.031

(57) ABSTRACT

An imaging alignment device, system and method. A sensor unit is provided that mounts to an imaging device and transmits orientation and perspective data to a base unit. The base unit provides information to facilitate placement of the imaging devices.

### CROSS-REFERENCE TO RELATED APPLICATIONS

The present application claims the benefit of U.S. Provisional Patent Application No. 60/958,910 filed Jul. 10, 2007 [Attorney Docket No.: 54338-7002], the contents of which are incorporated herein by reference.

### FEDERALLY SPONSORED RESEARCH OR DEVELOPMENT

Not Applicable.

### TECHNICAL FIELD

The invention generally relates to a device, system and method for aligning imaging devices to obtain images from a common perspective and orientation; and more particularly to a device, system and method including one or more sensors which generate and transmit orientation data of one or more imaging devices and a processing unit configured to process the data and facilitate alignment of the imaging devices to a common perspective and orientation.

### BACKGROUND OF THE INVENTION

Today's complex surgical operating rooms typically utilize ten or more video and data sources to display during surgery. Visual access to these images is becoming critically important during the clinical process, particularly in the case of Minimally Invasive Surgery (MIS), where surgery is performed with small incisions, using endoscopes. When captured (Digitized) these images also become an essential part of the medical record.

A typical operating room is a crowded environment, and likely to have limited video display monitors to show the resulting images. As such, a control system for routing these “many” sources to the “few” displays is required.

There is great value of using non-invasive Imaging Devices such as a C-Arm (i.e., a live X-Ray imager), during surgery. For example, because it reveals underlying structure, use of a C-Arm might facilitate the surgeon's decision on how to approach the proposed surgical site. However, it is often difficult to relate two images, particularly if the images are created from different imaging devices, having a different perspective and orientation. Similarly, it is also difficult to relate two images created from the same device if the images generated do not have the same perspective and orientation.

That is, comparing images, particularly a comparison of optical and non-optical, from very different sources, is difficult. Comparison of non-optical sources such as CAT scans and C-Arms, can be problematic. Ensuring that the images are from the same orientation and perspective is critical in the operating room environment.

With the evolving use of three dimensional (“3D”) scans and associated 3D digitized models, surgery is now migrating from MIS towards Image Guided Surgery (IGS) in an effort to increase surgical accuracy. For example, such techniques can be utilized where the results of an MRI scan, a database driven 3D model, has identified the location of a tumor in the brain. In this case Lasers are guided to excise the cancerous tissue.

These IGS systems are provided by companies such as Brainlab (BrainSuite®), Medtronic (StealthStation®) and Accuray (CyberKnife®). They rely on a number of factors: first, the generation of a 3D Scan, with the patient locked into a specific orientation, second, the ability to reposition that patient in an identical position during surgery, and third, the ability to direct the robot, laser, or other surgical instrument, using that 3D database, with great accuracy to a location in 3D space, and therefore perform surgery without damaging healthy tissue.

These automated, data driven solutions require information on absolute position in 3D space, and require use of technologies such as Micro GPS, or infrared optical tracker systems that rely on fiduciary markers.

In contrast, the present system and method is designed to help solve the issue of image management in operating rooms where the surgical team utilizes multiple, disparate imaging devices (fluoroscopes, ultrasound, microscopes, endoscopes and video cameras) during surgical procedures, without the high cost of full IGS systems. The present system does not require the use of a historical 3D Scan database, or automated surgical instruments. Neither does it rely on a Micro GPS, or equivalent technology to provide information on a location in 3D space. It is used to help the surgeon reposition an imaging device, or position a secondary imaging device, in the same orientation in 3D space, relative to a visually acquired “Target” location on the patient, so that the resulting images may be usefully compared, or overlaid in real time.

The present invention is provided to solve the problems discussed above and other problems, and to provide advantages and features not provided by prior alignment systems. A full discussion of the features and advantages of the present invention is deferred to the following detailed description, which proceeds with reference to the accompanying drawings.

### SUMMARY OF THE INVENTION

The present invention provides a device, system and method for aligning images taken from one or more image devices. The invention can be utilized in connection with surgical and other medical procedures to provide two or more images from the various image devices with the same orientation and perspective. This greatly enhances a medical practitioner's ability to determine the appropriate course of action.

Typical imaging devices, i.e. video and data sources, include: electronic patient records, digitized radiological images, endoscopic cameral images, patient vitals, surgical robot images, frozen section lab specimens, live radiological images, three dimensional navigation aid images, microscopy images, surgical light camera images, wall camera images, ultrasound device images, DVD playback, and videoconferences with outside clinicians.

In accordance with one embodiment of the invention, an imaging alignment system comprises a first sensor having a mounting for attachment to a first imaging device. The imaging device can be an optical device or a non-optical device. The first sensor is configured to generate and transmit orientation data and/or other related data such as positional data or perspective data, of the first imaging device. The first sensor can include a wireless transmitter for transmitting the orientation data to the base unit.

The system further includes a base processing unit, such as a, computer or other microprocessor based device, configured to receive the orientation data from the first sensor and to provide feedback to facilitate positioning of the first imaging device to a first orientation. The processing unit can use a visual and/or audio display to facilitate the positioning of the image device.

The system can further comprise a second sensor having a mounting attachment for attachment to a second imaging device. The second sensor is also configured to generate and transmit orientation data of the second imaging device. In fact, the system can utilize a plurality of such sensors for attachment to a plurality of imaging devices. The base unit is configured to provide feedback to facilitate positioning of the second imaging device (or others of the plurality of devices) to the first orientation.

The first sensor can include a rechargeable battery, an activation button and an indicator light. Additionally, the first sensor can be configured to receive alignment data from the base unit. The indicator light can be activated when the imaging device is in the first orientation.

The base unit can be utilized to provide calibration for the sensor units. It can also be used to recharge the sensor units.

In accordance with another embodiment of the invention an imaging alignment system comprises a first imaging device having a first sensor incorporated in the first imaging device and configured to generate and transmit orientation data of the first imaging device, and a base processing unit configured to receive the orientation data from the first sensor and to provide feedback to facilitate positioning of the first imaging device to a first orientation. The system further comprises a second sensor incorporated in a second imaging device. The second sensor is also configured to generate and transmit orientation data of the second imaging device to the base unit.

In accordance with yet a further embodiment of the invention, a method of aligning a first and second imaging device to a same orientation is provided. The method comprises providing a first sensor to a first imaging device; positioning the device to obtain an image of an object at a first orientation; transmitting positional and orientation data of the first imaging device to a processing unit; providing a second sensor to a second imaging device; transmitting positional and orientation data of the first imaging device to the processing unit; and, providing positioning information to facilitate positioning of the second imaging device to the first orientation. The step of providing positioning information to facilitate positioning of the second imaging device to the first orientation comprises displaying the positional information on a display.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a touch panel control interface for an operating control room;

FIG. 2 is a perspective view of an operating control room;

FIG. 3 is an image of a chest X-ray of a patient;

FIG. 4 is an external image from a light camera of the patient of FIG. 3;

FIG. 5 is an endoscopic camera image of a patient from a first perspective and orientation;

FIG. 6 is an endoscopic camera image of the patient of FIG. 5 from a second perspective and orientation;

FIG. 7 is an isometric image of a honeycomb article;

FIG. 8 is a front plan view of the article of FIG. 7;

FIG. 9 is a side plan view of the article of FIG. 7;

FIG. 10 is a perspective view of an operating room with a patient positioned below an imaging device;

FIG. 11 is the image of FIG. 3 overlayed over the image of FIG. 4;

FIG. 12 is a perspective view of a sensor for attaching to an imaging device in accordance with the present invention; and,

FIG. 13 is an image of a display from a processing unit in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

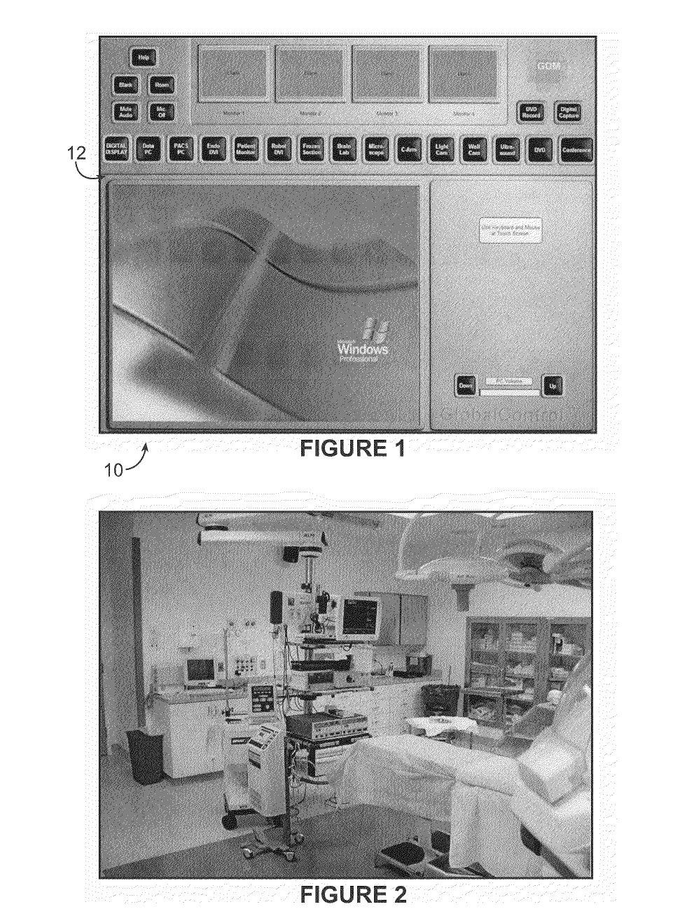

FIG. 1 shows a typical touchpanel control interface 10 for a control system in an operating room. The control interface includes controls 12 for displaying images from a number of image sources.

Referring to FIG. 2, the image sources utilized in a typical operating room environment include optical image sources such as endoscopes, microscopes and light cameras, along with non-optical image sources such as C-arms, Ultrasound, PC's and MRI. The images utilized may be produced live, or recorded from a different environment, such as a Cardiac Catheterization Lab, or Pathology Lab.

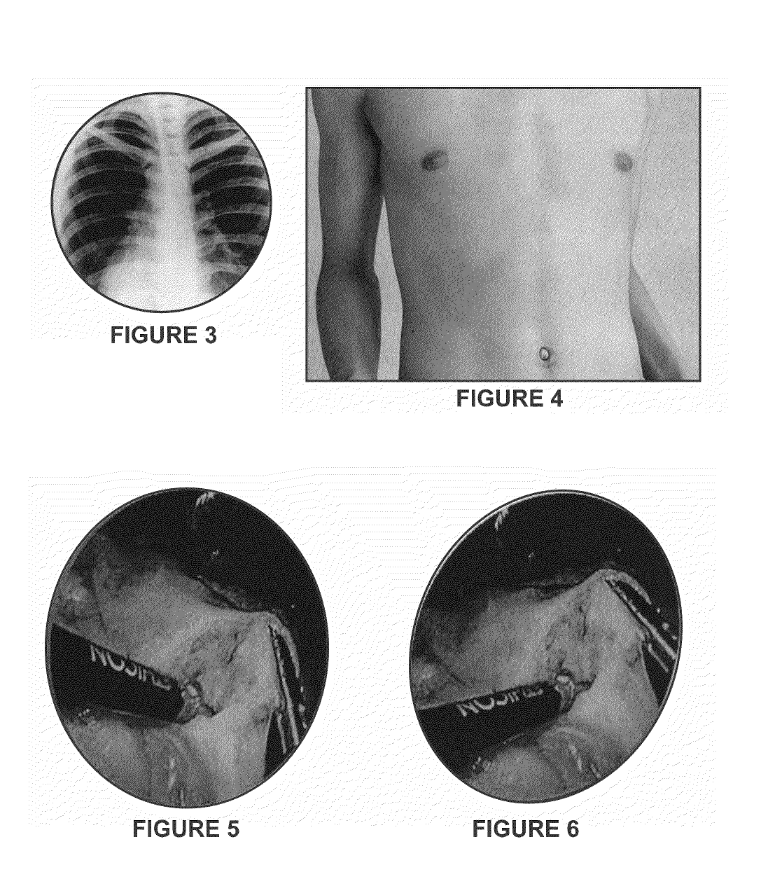

FIGS. 3 and 4 provide an example of two images of a Patient's chest. Specifically,

FIG. 4 shows an external image of the Patient's chest using a camera in the surgical light (i.e., a light camera) and FIG. 3 is an X-ray of the Patient's chest using a C-arm (i.e., a live X-ray imager). Unlike the light camera image, the C-arm image only shows a portion of the chest and includes a circular image boundary.

FIGS. 5 an 6 show an endoscopic camera image projected onto flat discs orientated at different angles. The different views provided by each image illustrates how much distortion can be created when viewing the same region or area of a Patient from different orientations.

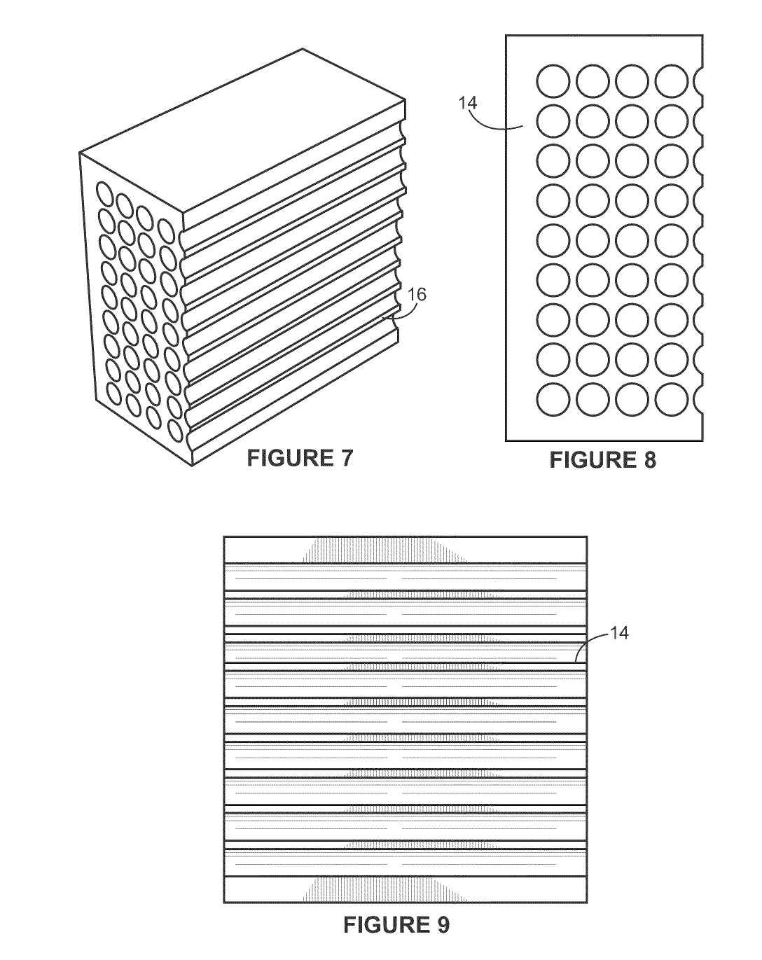

The problem of images having different perspectives and/or orientations is further illustrated in FIGS. 7-9. FIGS. 7-9 show an image of the same article 14 (i.e., a honeycombed rectangular object) from three different perspectives and orientations.

FIG. 7 provides an isometric view of the article 14 from above the article. In sharp contrast to this view, FIGS. 8 and 9 provide front and side plan views, respectively. It is evident from these views that the article 14 looks entirely different depending on the perspective and orientation of the image.

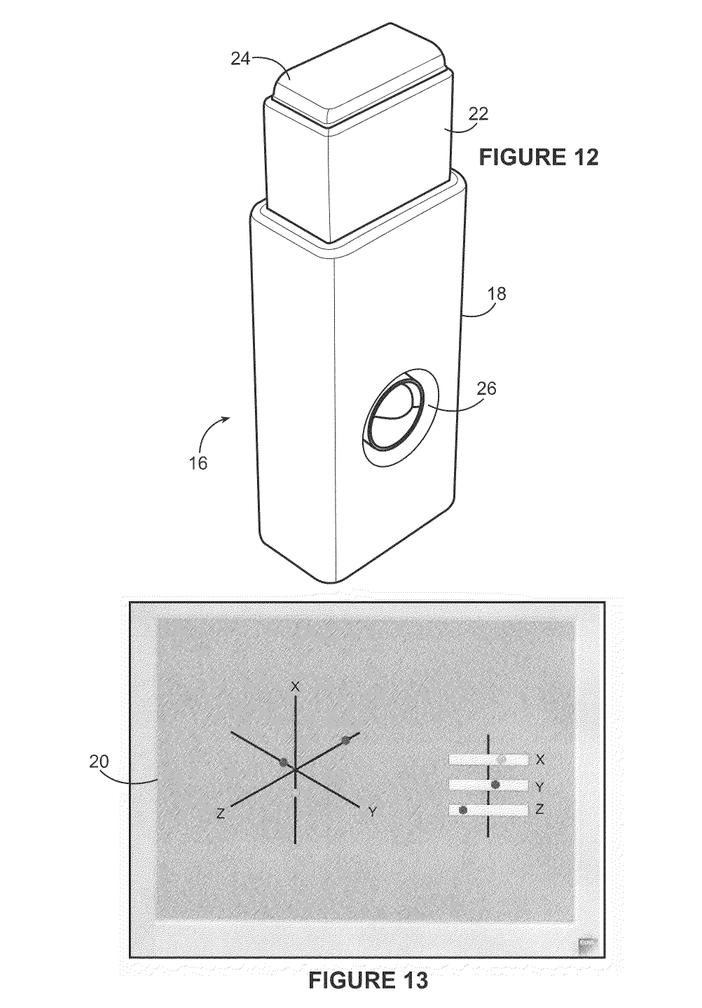

Referring to FIG. 12, the present invention utilizes an image alignment sensor unit 16 that can be attached to existing image devices in an operating room. Alternatively, new imaging devices can be made incorporating a sensor unit 16 directly into the devices.

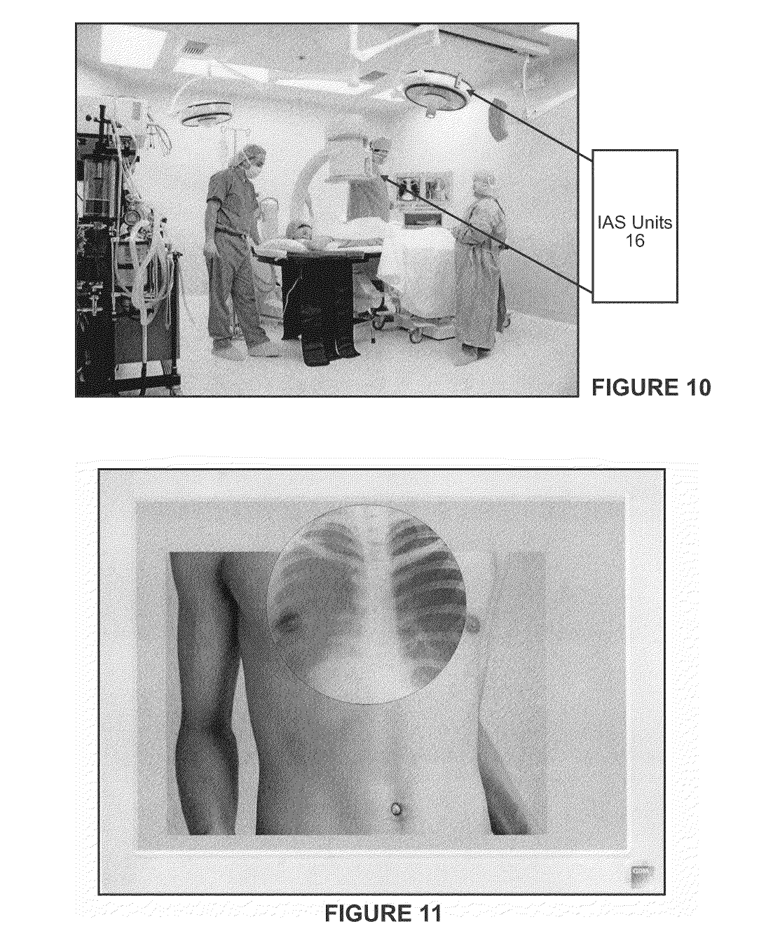

The sensor unit 16 includes a fixed mounting 18 for attachment to the image devices. Referring to FIG. 10, a sensor unit 16 is shown attached to a C-arm device and another unit 16 is attached to a Light Camera device in an operating room.

The C-Arm and the light camera are not physically connected and can be positioned (oriented) independently from different angles and perspectives potentially creating disparate images for use by the surgical team. However, by correctly aligning these two disparate imaging devices, the images created generate outputs that are similar in orientation and perspective. This allows the surgical team to view different anatomical structures (internal and external as an example) from different imaging devices at the exact same perspective, thus providing them more accurate comparative information for making decision on treatment and surgical approach.

The sensor units 16 are utilized to provide position and orientation feedback (i.e., data) to a base unit or main image alignment system processing unit (e.g., a computer or other microprocessor based device). FIG. 13 shows a screen shot 20 of the processing unit. Positional information is displayed on the screen 20.

The sensor units 16 are provided with a wireless transmission device 22 and are configured to wireless transmit the position and orientation data to the processing unit. Additionally, the sensors 16 can include an indicator light 24 and an activation switch 26. The sensor units 16 can also include a rechargeable battery.

The processing unit is configured to wirelessly receive the data from each sensor unit 16. The processing unit then processes the received data, and displays orientation and perspective feedback with the visual display 20 (the processing unit can also utilize an audio display) to help direct positioning of the imaging device or devices, and to supplement the sensor unit's onboard indicator light. The indicator light can be configured to go on when placed in the proper position. The processing unit is used to position the imaging devices to an appropriate location so that the image generated by the device is either consistent in perspective and orientation with prior images from the device, or with images from other devices.

The processing unit can perform multiple functions. These can include: calibration of sensor units 16, recharging of batteries, receiving and processing orientation signals, identifying specific imaging devices, display of resulting device orientation feedback, and so on. Additionally, the processing unit can be configured to consider additional information relating to the imaging devices to facilitate proper positioning. Such information can include, for example the size and shape of the image device, and/or the distance of sensor unit 16 from the lens or focal point of the device.

Using the image alignment system with existing imaging devices (C-arm and Light Camera as an example), it is possible to facilitate orienting any imaging device accurately and to the same perspective, every time. This process ensures that image outputs can be easily compared live or captured (digitized) on separate displays. Moreover, the images can even be superimposed on a single display such as shown in FIG. 11. The superimposing can be performed manually (e.g., with use of a computer mouse) or with software.

Alignment of the images using the present system in the operating room, and potentially other acute clinical areas of the hospital, provides a clinical team more accurate comparative information for making decisions on the appropriate treatment and surgical approach.

While the specific embodiments have been illustrated and described, numerous modifications come to mind without significantly departing from the spirit of the invention, and the scope of protection is only limited by the scope of the accompanying Claims.

What is claimed is:

1. An imaging alignment system comprising:
a first sensor having a mounting for attachment to a first imaging device, the first sensor configured to generate and transmit orientation data of the first imaging device;
a base processing unit configured to receive the orientation data from the first sensor and to provide feedback to facilitate positioning of the first imaging device to a first orientation.

2. The imaging alignment system of claim 1 wherein the first sensor includes a wireless transmitter for transmitting the orientation data to the base unit.

3. The imaging alignment system of claim 1 wherein the base unit includes a visual display to provide the feedback.

4. The imaging alignment system of claim 1 further comprising a second sensor having a mounting attachment for attachment to a second imaging device, the second sensor configured to generate and transmit orientation data of the second imaging device.

5. The imaging alignment system of claim 4 wherein the base unit is configured to provide feedback to facilitate positioning of the second imaging device to the first orientation.

6. The imaging alignment system of claim 1 wherein the first sensor includes a rechargeable battery.

7. The imaging alignment system of claim 1 wherein the first sensor is configured to receive alignment data from the base unit.

8. The imaging alignment system of claim 7 wherein the first sensor includes an indicator light that is activated when the imaging device is in the first orientation.

9. The imaging alignment system of claim 1 wherein the base unit is configured to provide calibration for the first sensor unit.

10. The imaging alignment system of claim 1 wherein the first sensor is mounted on a C-arm X-ray device.

11. The imaging alignment system of claim 10 wherein the second sensor is mounted on a Light Camera.

12. An imaging alignment system comprising:
a first imaging device having a first sensor incorporated in the first imaging device, the first sensor configured to generate and transmit orientation data of the first imaging device;
a base processing unit configured to receive the orientation data from the first sensor and to provide feedback to facilitate positioning of the first imaging device to a first orientation.

13. The system of claim 12 further comprising a second sensor incorporated in a second imaging device, the second sensor configured to generate and transmit orientation data of the second imaging device to the base unit.

14. A method of aligning a first and second imaging device to a same orientation comprising:
providing a first sensor to a first imaging device;
positioning the device to obtain an image of an object at a first orientation;
transmitting positional and orientation data of the first imaging device to a processing unit;
providing a second sensor to a second imaging device;
transmitting positional and orientation data of the first imaging device to the processing unit; and,
providing positioning information to facilitate positioning of the second imaging device to the first orientation.

15. The method of claim 14 wherein the step of providing positioning information to facilitate positioning of the second imaging device to the first orientation comprises:
displaying the positional information on a display.
